(19) United States
(12) Patent Application Publication
(10) Pub. No.: US 2021/0129516 A1
(43) Pub. Date: May 6, 2021

(54) LAMINATE, METHOD OF MANUFACTURING LAMINATE, AND DEVICE FOR MANUFACTURING LAMINATE

(71) Applicant: Yoshiki YANAGAWA, Tokyo (JP)

(72) Inventor: Yoshiki YANAGAWA, Telford (GB)

(21) Appl. No.: 16/640,095

(22) PCT Filed: Nov. 12, 2018
(86) PCT No.: PCT/JP2018/041836

§ 371 Date: Feb. 19, 2020

(30) Foreign Application Priority Data
Nov. 15, 2017 (JP) 2017-219676
Jul. 27, 2018 (JP) 2018-141823
Sep. 28, 2018 (JP) 2018-185369

(51) Int. Cl. B32B 37/14; B32B 38/00; B32B 37/00

(52) U.S. Cl. CPC B32B 37/14; B32B 38/145; B32B 37/0053; B32B 2307/4023; B32B 2038/0076; B32B 2305/72; B32B 2451/00

(57) ABSTRACT

A laminate includes a substrate, a decorative base sheet, a print layer containing an alcohol having a boiling point of 180 degrees C. or higher, and a cross-linked resin. The cross-linked resin is obtained in such a manner that the resin contained in the decorative base sheet or an overlay layer forms a cross-linked structure using the alcohol contained in the print layer as the cross-linking component.

### TECHNICAL FIELD

The present disclosure relates to a laminate, a method of manufacturing a laminate, and a device for manufacturing a laminate.

### BACKGROUND ART

Low-pressure melamine decorative boards and high-pressure melamine decorative boards are known as decorative boards used for wall materials and floor materials. Low-pressure melamine decorative boards are manufactured by, for example, laminating substrates such as decorative base sheets and medium density fiberboards (MDF) which are impregnated with a melamine resin and adhering to each other via the melamine resin upon application of heat and pressure. High-pressure melamine decorative boards are manufactured by, for example, laminating a decorative base sheet impregnated with a melamine resin, a core base sheet impregnated with a phenolic resin, etc. followed by applying heat and pressure to obtain a laminar object, and gluing the laminar object to a substrate with an adhesive.

Designability of the decorative base sheet used for these decorative boards is known to be controlled by a method such as gravure printing, flexographic printing, and offset printing. Also, unlike the above-described printing methods using plates, technologies of inkjet printing is also known to enable a small quantity of printing.

A technology is disclosed in WO 2014/084280, which includes printing on a decorative base sheet by inkjet method to obtain printed matter and impregnating the printed matter with a melamine resin-impregnating liquid to produce a decorative board.

A technology is disclosed in JP-2005-1146-A1, which includes bearing a thermocurable resin on a decorative sheet, heating the thermocurable resin to remove an organic solvent and water, and forming a print layer by inkjet printing to produce a decorative board.

A technology is disclosed in JP-2015-86373-A1, which includes forming a primer layer on the surface of a decorative material base sheet containing a melamine resin and applying a polymerizable ink reactionable with the primer layer by inkjet printing to produce a decorative material.

### CITATION LIST

### Patent Literature

[PTL 1] WO 2014/084280

[PTL 2] JP-2005-1146-A

[PTL 3] JP-2015-86373-A

### SUMMARY OF INVENTION

### Technical Problem

The present disclosure is to provide a laminate having a high interlayer adhesiveness.

### Solution to Problem

The laminate according to the present disclosure is as described below.

A laminate includes a substrate, a decorative base sheet, a print layer containing an alcohol having a boiling point of 180 degrees C. or higher, and a cross-linked resin.

### Advantageous Effects of Invention

The laminate of the present disclosure has excellent adhesiveness between layers.

### BRIEF DESCRIPTION OF DRAWINGS

Various other objects, features and attendant advantages of the present invention will be more fully appreciated as the same becomes better understood from the detailed description when considered in connection with the accompanying drawings in which like reference characters designate like corresponding parts throughout and wherein:

FIG. 1A is a schematic diagram illustrating a device for manufacturing a laminate according to an embodiment of the present disclosure.

FIG. 1B is a schematic diagram illustrating a device for manufacturing a laminate according to another embodiment of the present disclosure.

FIG. 2A is a schematic diagram illustrating a device for manufacturing a laminate according to another embodiment of the present disclosure.

FIG. 2B is a schematic diagram illustrating a device for manufacturing a laminate according to another embodiment of the present disclosure.

FIG. 3 is a schematic diagram illustrating a device for manufacturing a laminate according to another embodiment of the present disclosure.

### DETAILED DESCRIPTION OF THE EMBODIMENTS

In describing embodiments illustrated in the drawings, specific terminology is employed for the sake of clarity. However, the disclosure of this specification is not intended to be limited to the specific terminology so selected and it is to be understood that each specific element includes all technical equivalents that have a similar function, operate in a similar manner, and achieve a similar result. As used herein, the singular forms “a”, “an”, and “the” are intended to include the plural forms as well, unless the context clearly indicates otherwise. Moreover, image forming, recording, printing, modeling, etc. in the present disclosure represent the same meaning, unless otherwise specified.

The present disclosure relates to the laminate of the following (1) and also includes the following (2) to (12) as embodiments.

(1). A laminate includes a substrate, a decorative base sheet, a print layer containing an alcohol having a boiling point of 180 degrees C. or higher, and a cross-linked resin.
(2). The laminate according to (1) mentioned above, wherein the alcohol is a cross-linking component of the cross-linked resin.
(3) The laminate according to (1) or (2) mentioned above, wherein the decorative base sheet contains a resin.
(4) The laminate according to any one of (1) to (3) mentioned above, further includes an overlay layer containing a resin and/or the resin.
(5) The laminate according to (3) mentioned above, wherein the resin in the decorative base sheet is an amino resin.
(6) The laminate according to (4) mentioned above, wherein the resin contained in the overlay layer is an amino resin.
(7) The laminate according to any one of (1) to (6), wherein the alcohol has a boiling point of 230 degrees C. or higher.
(8) A method of manufacturing a laminate includes jetting an ink containing an alcohol having a boiling point of 180 degrees C. or higher as a solvent to a decorative base sheet to form a print layer; applying a resin-containing liquid to the decorative base sheet;
laminating the decorative base sheet to a substrate to obtain a laminar object; and applying heat and pressure to the laminar object to form the laminate.
(9) The method according to (8) mentioned above, further including laminating an overlay layer on the surface of the print layer.
(10) A method of manufacturing a laminate includes jetting an ink containing an alcohol having a boiling point of 180 degrees C. or higher as a solvent to a decorative base sheet to form a print layer, laminating an overlay layer on the surface of the print layer, laminating the decorative base sheet to a substrate to obtain a laminar object, and applying heat and pressure to the laminar object to form the laminate.
(11) A device for manufacturing a laminate includes a conveying device to convey a decorative base sheet along a conveyance path, an inkjet device to form a print layer on the decorative base sheet, an application device to apply a resin-containing liquid to the decorative base sheet, a laminating device to laminate the decorative base sheet to a substrate to obtain a laminar object, and a heating and pressurizing device to apply heat and pressure to the laminar object to obtain the laminate, wherein the inkjet device and the application device are continuously disposed along the conveyance path.
(12) A device for manufacturing a laminate includes a conveying device to convey a decorative base sheet along a conveyance path, an inkjet device to form a print layer on the decorative base sheet, an overlay layer-laminating device to laminate an overlay layer containing a resin on the surface of the print layer, a laminating device to laminate the decorative base sheet to a substrate to obtain a laminar object and a heating and pressurizing device to apply heat and pressure to the laminar object to obtain the laminate, wherein the inkjet device and the overlay layer-laminating device are continuously disposed along the conveyance path.

Next, aspects of the present disclosure are described.

Laminate

The laminate of the present disclosure includes a substrate, a decorative base sheet, a print layer containing an alcohol having a boiling point of 180 degrees C. or higher, and a cross-linked resin.

The laminate of the present disclosure can be applied to a decorative board (or panel) used as a wall material, floor materials, etc.

Substrates for use in a laminate such as a decorative board (panel) impart mechanical strength, good handling property, etc. to the laminate. For examples, the substrate can be a general material, typically wood.

Specific examples include, but are not limited to, veneer, wood veneer, wood plywood, particle board, medium density fiberboard (MDF), oriented strand board (OSD) made of materials such as cedar, cypress, Japanese cypress, pine, lavan, cheek, and Melapi. Of these, particle board or MDF is preferable in terms of mechanical strength, price, and availability. The substrate is not limited to materials mainly made of wood but can be an article having the features mentioned above.

Decorative Base Sheet

For example, a structure capable of holding a resin-containing liquid inside such as a fibrous structure or a porous structure can be the decorative base sheet.

Specifically, typical decorative base sheet for use in the process of typical printing such as gravure printing, flexographic printing, offset printing, etc. can be used. As is well known, the decorative base sheet contains pulp, synthetic fiber, etc. Furthermore, the decorative base sheet is a paper material suitably containing additives such as titanium oxide, talc, clay, kaolin, calcium carbonate, a coloring agent, a wet strength enhancer, a coagulant, and a pH regulator. It is preferable to produce the decorative base sheet by a paper-making machine such as a Fourdrinier machine. In addition, the ash proportion in the decorative base sheet is generally preferably in the range of from 20 to 40 percent by mass. The basis weight of the decorative base sheet is not particularly limited but is preferably from 50 to 150 g/m². The decorative base sheet can be any article capable of holding a resin-containing liquid, for example, a film having a fibrous structure, a porous structure, etc.

Print Layer

The print layer contains an alcohol having a boiling point of 180 degrees C. or higher and optionally other components such as a coloring material, other organic solvents, and additives.

To form a print layer containing an alcohol having a boiling point of 180 degrees C. or higher, a liquid (ink) forming the print layer is caused to contain an alcohol having a boiling point of 180 degrees C. or higher. Due to the inclusion of an alcohol having a boiling point of 180 degrees C. or higher in the print layer, a laminate having a cross-linked structure in which the resin is cross-linked is obtained. Also, due to the inclusion of the alcohol having a boiling point of 180 degrees C. or higher in the liquid (ink), sharp drying of the ink around the nozzles of an inkjet head and clogging in the nozzles can be prevented during discharging even for a long period of time, thereby achieving good discharging stability and image quality. In addition, an alcohol having a boiling point of 180 degrees C. or higher can also reduce production of bubbles caused by vaporization occurring in the step of applying heat and pressure to manufacture a decorative board, which is described later. This makes it possible to reduce degradation of adhesiveness in the decorative board.

Resin

The decorative base sheet constituting the laminate of the present disclosure may optionally furthermore contain a resin or a cross-linked resin. A resin-containing liquid containing a resin or a precursor of the resin is applied to a medium such as a decorative base sheet to obtain a decorative base sheet containing the resin or the cross-linked resin.

Of the resins, amino resins are good in terms of adhesiveness between the decorative base sheet and a member disposed adjacent thereto. Also, amino resins are preferable because it is sufficiently reactive with the alcohol contained in the print layer for cross-linking, thereby achieving excellent adhesiveness.

The resin-containing liquid permeates the print layer and undergoes a cross-linking reaction with the alcohol contained in the print layer to form a cross-linked structure in the print layer and at the interface between the print layer and the decorative base sheet, which is inferred to enhance adhesiveness between the print layer and the decorative base sheet.

Overlay Layer

The overlay layer is a protection layer to enhance durability of the print layer of the decorative base sheet and can be suitably used to suit to a particular application.

This overlay layer can impart mechanical strength, heat resistance, chemical resistance, etc. to the surface of a decorative board. It is possible to use an article in which paper or film is impregnated with a resin such as a melamine as the overlay layer. Transparent paper containing little or no ash is preferable as paper. As the paper, for example, wood pulp fiber paper containing a large amount of α-cellulose components, linter cotton fiber paper, polyester film, etc. can be used.

When an overlay layer contains a melamine resin, the melamine resin permeates the print layer in the step of heating and pressurizing and cross-links with alcohol contained in the print layer to form a cross-linked structure at the interface between the print layer and the overlay layer, which is inferred to enhance adhesiveness between the print layer and the overlay layer.

Method of Manufacturing Laminate

The laminate of the present disclosure includes a cross-linked structure in which the resin is cross-linked. The resin is applied to a decorative base sheet to which the print layer containing an alcohol having a boiling point of 180 degrees C. or higher is provided to obtain a constitution of the decorative base sheet including the resin. Thereafter, a substrate is laminated to this structure to obtain a laminar object, which is thereafter heated under pressure to obtain the laminate of the present disclosure. The decorative base sheet is impregnated with a resin-containing liquid to apply the resin to the decorative base sheet.

The print layer can be formed by jetting (discharging) ink by an inkjet method.

In addition, when the printed decorative base sheet contains liquid such as a solvent contained in the resin-containing liquid, this liquid may be dried (evaporated) and removed. Moreover, it is possible to laminate an overlay layer, etc., and thereafter apply heat and pressure to the laminar object. In addition, when an overlay layer in which paper or film is impregnated with a resin such as a melamine resin is used, it is possible to provide a process of impregnating a decorative base sheet with a resin-containing liquid. Also, it is possible to obtain a laminate without providing the process of impregnating a decorative base sheet with a resin-containing liquid. In this case, the alcohol having a boiling point of 180 degrees C. or higher contained in the print layer and the resin such as a melamine resin contained in the overlay layer form a cross-linked structure as the laminate of the present disclosure.

As the method of applying heat and pressure, it is preferable to use a heating and pressurizing device such as a hot press to apply a pressure of from 10 to 180 kg/cm² at a temperature range of from 70 to 220 degrees C. for 3 to 60 minutes. Due to application of heat and pressure, a laminate such as a decorative board can be obtained in which each layer adheres to each other and is unified. Also, it is possible to use typically-used core paper impregnated with a phenolic resin between each of a print medium layer such as a decorative printing sheet (=decorative base sheet+print layer), a substrate layer, and an overlay layer. This laminate has excellent adhesiveness between layers and manufacturing efficiency, which can be preferably used as a building material. The method of manufacturing a decorative board as an example of the laminate is described below.

Printing Process

The method of manufacturing a laminate of the present disclosure includes applying an ink to a decorative base sheet for printing. The print layer formed during the printing is formed on or in the decorative base sheet and contains alcohol having a boiling point of 180 degrees C. or higher. For example, an ink containing an alcohol having a boiling point of 180 degrees C. or higher and other optional component such as a coloring material and water is used to form the print layer in the present disclosure.

Component of Ink

Organic Solvent

The ink for use in the present disclosure contains an alcohol having a boiling point of 180 degrees C. or higher as an organic solvent and other optional materials such as a coloring material, water, and an additive. In addition, organic solvents other than alcohol can be used in combination.

Alcohol has a hydroxy group as a functional group cross-linkable (reactive) with the resin contained in the resin-containing liquid or the overlay layer. “Cross-linkable (reactive)” means forming a covalent bond between the organic solvent (alcohol) and at least one of the resin and the resin precursor contained in the resin-containing liquid. As a consequence, a laminate including a crosslinked structure can be obtained.

For example, when the resin-containing liquid contains precursors of amino resins such as melamine resins, guanamine resins, and benzoguanamine resins, hydroxy group as the functional group in the alcohol having a boiling point of 180 degrees C. or higher reacts with the resins, thereby forming a cross-linked structure.

Specific examples of the alcohol having a boiling point of 180 degrees C. or higher for use in the present disclosure include, but are not limited to, the following.

The alcohol in the present disclosure has a hydroxyl group and is used as an organic solvent. It may contain an ether bond in its molecule. The print layer may contain an alcohol having a boiling point lower than 180 degrees C. in addition to the alcohol having a boiling point lower than 180 degrees C. or higher.

Straight-chain alcohols such as lauryl alcohol (boiling point of 259 degrees C.), cetyl alcohol (boiling point of 190 degrees C.), stearyl alcohol (boiling point of 210 degrees C.), behenyl alcohol (boiling point of 180 degrees C.), myristyl alcohol (boiling point of 260 degrees C. or higher), oleyl alcohol (boiling point of 207 degrees C.), and cetostearyl alcohol (about 350 degrees C.), and higher alcohols such as branched chain alcohols such as monostearyl glycerin ether (batyl alcohol, boiling point of 471 degrees C.), 2-decyltetradecinol (boiling point of 271 degrees C.), lanolin alcohol, cholesterol (boiling point of 360 degrees C.), phytosterol, hexyldodecanol, isostearyl alcohol, octyldodecanol (boiling point of 223 degrees C.),

Dihydlic alcohols such as ethylene glycol (boiling point of 197 degrees C.), propylene glycol (boiling point of 188 degrees C.), trimethylene glycol (boiling point of 287 degrees C.), 1,2-butanediol (boiling point of 194 degrees C.), 1,3-butanediol (boiling point of 207 degrees C.), tetramethylene glycol, tetraethylene glycol (boiling point of 328 degrees C.), 2,3-butanediol (boiling point of 183 degrees C.), pentamethylene glycol (boiling point of 239 degrees C.), 2-butene-1,4-diol (boiling point of 235 degrees C.), hexylene glycol (boiling point of 197 degrees C.), and octylene glycol, trihydric alcohols such as glycerin (boiling point of 290 degrees C.) and trimethylolpropane (boiling point of 295 degrees C.), quadri-hydlic alcohol such as pentaerythritol (boiling point of 276 degrees C.), five-valent hydlic alcohol such as xylitol (boiling point of 216 degrees C.), six-valent alcohols such as sorbitol (boiling point: 296 degrees C.), and mannitol (boiling point of 290 degrees C.);

Polyol polymers such as diethylene glycol (boiling point of 244 degrees C.), dipropylene glycol (boiling point of 231 degrees C.), triethylene glycol (boiling point of 276 degrees C.), polypropylene glycol, tetraethylene glycol (boiling point of 328 degrees C.), diglycerin, polyethylene glycol, triglycerin, tetraglycerin, polyglycerin, and polyethylene glycol monomethyl ether.

Divalent alcohol alkyl ethers such as ethylene glycol monophenyl ether (boiling point of 237 degrees C.), ethylene glycol monohexyl ether (boiling point of 205 degrees C.), ethylene glycol mono 2-methylhexyl ether (boiling point of 229 degrees C.), ethylene glycol isoamyl ether, and ethylene glycol benzyl ether (boiling point of 256 degrees C.),

Dihydlic alcohol alkylethers such as diethylene glycol monomethyl ether (boiling point of 193 degrees C.), diethylene glycol monoethyl ether (boiling point of 196 degrees C.), diethylene glycol monobutyl ether (boiling point of 230 degrees C.), triethylene glycol monomethyl ether (boiling point of 248 degrees C.), triethylene glycol monoethyl ether (boiling point of 255 degrees C.), propylene glycol monomethyl ether (boiling point of 121 degrees C.), propylene glycol isopropyl ether, dipropylene glycol methyl ether (boiling point of 188 degrees C.), dipropylene glycol ethyl ether, and dipropylene glycol butyl ether (boiling point of 222 degrees C.), sugar alcohols such as sorbitol (boiling point of 296 degrees C.), mannitol (boiling point of 290 degrees C.), and erythritol (boiling point of 329 degrees C.).

Of the alcohols, diethylene glycol monobutyl ether (butane diol (boiling point of 230 degrees C.), 1,3-butanediol (boiling point of 207 degrees C.), dipropylene glycol monomethyl ether (boiling point of 188 degrees C.), and polyethylene glycol monomethylether are preferable and polyethylene glycol monomethylether are particularly preferable. These alcohols can be used alone or in combination. The combination of two or more kinds and the ratio in the combination can be suitably selected to suit to a particular application.

The alcohol preferably accounts for 60 percent by mass or more, more preferably 65 percent by mass or more, furthermore preferably 80 percent by mass or more, and particularly preferably 90 percent by mass or more of the total amount of ink. When the alcohol is contained in an amount of 60 percent by mass or more in the ink, the ratio of the cross-linked structure can be increased. Due to this, in the step of manufacturing a laminate by applying heat and pressure described later, production of bubbles ascribable to vaporization of the uncross-linked liquid can be reduced. As a consequence, deterioration of interlayer adhesiveness in the laminate can be reduced. Therefore, all of the organic solvent components contained in ink may be alcohol.

In addition, such an alcohol has a boiling point of 180 degrees C. or higher, preferably 200 degrees C. or higher, more preferably 230 degrees C. or higher, and furthermore preferably 290 degrees C. or higher. Due to inclusion of this alcohol having a boiling point of 180 degrees C. or higher in ink, sharp drying of the ink around the nozzles of an inkjet head and clogging in the nozzles can be prevented for discharging even for a long period of time, thereby achieving good discharging stability and image quality. In addition, an alcohol having a boiling point of 180 degrees C. or higher can also reduce production of bubbles caused by vaporization occurring in the step of applying heat and pressure to manufacture a laminate, which is described later. This makes it possible to reduce degradation of adhesiveness in the laminate.

In addition, it is preferable to contain an alcohol having a boiling point of 180 degrees C. or higher in an amount of 60 percent by mass to the total amount of ink.

In addition, the alcohol contained in the ink relating to the present disclosure preferably has a viscosity of 40 mPa-s or less and preferably 15 mPa-s or less at room temperature (25 degrees C.). When viscosity is 40 mPa-s or less, the viscosity of the prescribed ink belongs to the viscosity range suitable for discharging in an ink jet head, thereby obtaining good discharging stability and image quality.

Coloring Material

As the coloring materials, pigments and dyes can be used. Known inorganic pigments and organic pigments are preferable in terms that good coloring on a decorative printing sheet is required even after the step of heating and pressurizing.

As the inorganic pigment and the organic pigment, for example, the following is usable: inorganic pigments such as carbon black manufactured by a furnace method or a channel method, a sulfate of an alkaline earth metal such as barium sulfate, a carbonate of an alkaline earth metal such as calcium carbonate, silicas such as fine powder silicic acid and synthesized silicate, calcium silicate, alumina, alumina hydrate, titanium oxide, zinc oxide, talc, and clay, and organic pigment such as azo-based pigments, phthalocyanine-based pigments, quinacridone-based pigments, perylene-based pigments, nitroso-based pigments, nitro-based pigments, isoindolinone-based organic pigments, pyranthrone-based organic pigments, thioindigo-based organic pigments, benzimidazolone-based organic pigments, quinophthalone-based pigments, isoindoline-based pigment, vat dye-based pigments, mordant dye-based pigments, basic dye-based pigments, acidic dye-based pigments, and natural dye-based pigments.

Known methods such as a gravure method, a flexo method, an offset method, and an inkjet method can be used to form the print layer, and an ink containing a coloring material is applied to the decorative base sheet by these methods. As a method of forming the print layer, inkjet methods are preferable.

Water

The proportion of water in the ink is not particularly limited and can be suitably determined to suit to a particular application. and can be 0 to 90 percent by mass. The proportion of water in the ink is preferably from 0 to 40 percent by mass, more preferably from 0 to 30 percent by mass, and particularly preferably from 0 to 25 percent by mass. When the proportion of water is decreased, the proportion of alcohol is increased. Therefore, sharp drying of the ink around the nozzles of an inkjet head and clogging in the nozzles can be prevented during discharging even for a long period of time, thereby achieving good discharging stability and image quality. In addition, in the step of manufacturing a decorative plate by applying heat and pressure, production of bubbles ascribable to vaporization of water can be diminished. As a consequence, deterioration of adhesiveness in a laminate can be reduced.

Therefore, the proportion of water is preferably in the above range. However, the ink does not necessarily contain water.

Additive

Ink may further optionally include a surfactant, a defoaming agent, a preservative and fungicide, a corrosion inhibitor, a pH regulator, etc.

Surfactant

Examples of the surfactant are silicone-based surfactants, fluorochemical surfactants, amphoteric surfactants, nonionic surfactants, anionic surfactants, etc.

The silicone-based surfactant has no specific limit and can be suitably selected to suit to a particular application.

Of these, preferred are silicone-based surfactants which are not decomposed even in a high pH environment. Specific examples include, but are not limited to, sidechain-modified polydimethylsiloxane, both-distal-end-modified polydimethylsiloxane, one-distal-end-modified polydimethylsiloxane, and sidechain-both-distal-end-modified polydimethylsiloxane. A silicone-based surfactant having a polyoxyethylene group or a polyoxypropylene group as a modification group is particularly preferable because such an agent demonstrates good properties as an aqueous surfactant. It is possible to use a polyether-modified silicone-based surfactant as the silicone-based surfactant. A specific example is a compound in which a polyalkylene oxide structure is introduced into the side chain of the Si site of dimethyl siloxane.

Specific examples of the fluorochemical surfactants include, but are not limited to, perfluoroalkyl sulfonic acid compounds, perfluoroalkyl carboxylic acid compounds, ester compounds of perfluoroalkyl phosphoric acid, adducts of perfluoroalkyl ethylene oxide, and polyoxyalkylene ether polymer compounds having a perfluoroalkyl ether group in its side chain. These are particularly preferable because they do not easily produce foams.

Specific examples of the perfluoroalkyl sulfonic acid compounds include, but are not limited to, perfluoroalkyl sulfonic acid and salts of perfluoroalkyl sulfonic acid. Specific examples of the perfluoroalkyl carboxylic acid compounds include, but are not limited to, perfluoroalkyl carboxylic acid and salts of perfluoroalkyl carboxylic acid. Specific examples of the polyoxyalkylene ether polymer compounds having a perfluoroalkyl ether group in its side chain include, but are not limited to, salts of sulfuric acid ester of polyoxyalkylene ether polymer having a perfluoroalkyl ether group in its side chain and salts of polyoxyalkylene ether polymers having a perfluoroalkyl ether group in its side chain. Counter ions of salts in these fluorochemical surfactants are, for example, Li, Na, K, NH₄, NH₃CH₂CH₂OH, NH₂(CH₂CH₂OH)₂, and NH(CH₂CH₂OH)₃.

Specific examples of the amphoteric surfactants include, but are not limited to, lauryl aminopropionic acid salts, lauryl dimethyl betaine, stearyl dimethyl betaine, and lauryl dihydroxyethyl betaine.

Specific examples of the nonionic surfactants include, but are not limited to, polyoxyethylene alkyl phenyl ethers, polyoxyethylene alkyl esters, polyoxyethylene alkyl amines, polyoxyethylene alkyl amides, polyoxyethylene propylene block polymers, sorbitan aliphatic acid esters, polyoxyethylene sorbitan aliphatic acid esters, and adducts of acetylene alcohol with ethylene oxides.

Specific examples of the anionic surfactants include, but are not limited to, polyoxyethylene alkyl ether acetates, dodecyl benzene sulfonates, laurates, and polyoxyethylene alkyl ether sulfates.

These can be used alone or in combination.

The silicone-based surfactant has no particular limit and can be suitably selected to suit to a particular application.

Specific examples include, but are not limited to, side-chain-modified polydimethyl siloxane, both distal-end-modified polydimethylsiloxane, one-distal-end-modified polydimethylsiloxane, and side-chain-both-distal-end-modified polydimethylsiloxane. In particular, a polyether-modified silicone-based surfactant having a polyoxyethylene group or a polyoxyethylene polyoxypropylene group is particularly preferable because such a surfactant demonstrates good property as an aqueous surfactant.

Any suitably synthesized surfactant and any product available on the market is suitable. Products available on the market can be obtained from Byc Chemie Japan Co., Ltd., Shin-Etsu Silicone Co., Ltd., Dow Corning Toray Co., Ltd., etc., NIHON EMULSION Co., Ltd., Kyoeisha Chemical Co., Ltd., etc.

The polyether-modified silicon-based surfactant has no particular limit and can be suitably selected to suit to a particular application. For example, a compound is usable in which the polyalkylene oxide structure represented by the following Chemical formula S-1 is introduced into the side chain of the Si site of dimethyl polysiloxane.

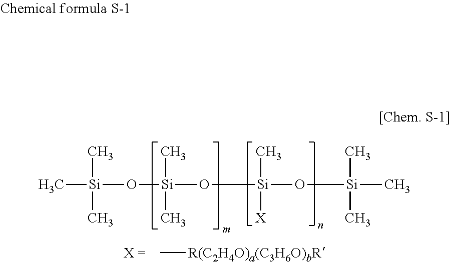

In the Chemical formula S-1, “m”, “n”, “a”, and “b” each, respectively independently represent integers, R represents an alkylene group, and R′ represents an alkyl group. Specific examples of polyether-modified silicone-based surfactants include, but are not limited to, KF-618, KF-642, and KF-643 (all manufactured by Shin-Etsu Chemical Co., Ltd.), EMALEX-SS-5602 and SS-1906EX (both manufactured by NIHON EMULSION Co., Ltd.), FZ-2105, FZ-2118, FZ-2154, FZ-2161, FZ-2162, FZ-2163, and FZ-2164 (all manufactured by Dow Corning Toray Co., Ltd.), BYK-33 and BYK387 (both manufactured by BYK Japan KK.), and TSF4440, TSF4452, and TSF4453 (all manufactured by Momentive Performance Materials Inc.).

A fluorochemical surfactant in which the number of carbon atoms replaced with fluorine atoms is 2 to 16 is preferable and, 4 to 16, more preferable.

Specific examples of the fluorochemical surfactants include, but are not limited to, perfluoroalkyl phosphoric acid ester compounds, adducts of perfluoroalkyl ethylene oxide, and polyoxyalkylene ether polymer compounds having a perfluoroalkyl ether group in its side chain. Of these, polyoxyalkylene ether polymer compounds having a perfluoroalkyl ether group in its side chain are preferable because they do not foam easily and the fluorosurfactant represented by the following Chemical formula F-1 or Chemical formula F-2 is more preferable.

CF₃CF₂(CF₂CF₂)ₘ—CH₂CH₂O(CH₂CH₂O)ₙH Chemical formula F-1

In the compound represented by Chemical formula F-1, “m” is preferably 0 or an integer of from 1 to 10 and “n” is preferably 0 or an integer of from 1 to 40. CₙF₂ₙ₊₁—CH₂CH(OH)CH₂—O—(CH₂CH₂O)ₙ—Y Chemical formula F-2 In the compound represented by the chemical formula F-2, Y represents H or CₘF₂ₘ₊₁, where m represents an integer of from 1 to 6, or CH₂CH(OH)CH₂—CₘF₂ₘ₊₁, where m represents an integer of from 4 to 6, or CₚH₂ₚ₊₁, where p is an integer of from 1 to 19. “n” represents an integer of from 1 to 6. “a” represents an integer of from 4 to 14. As the fluorochemical surfactant, products available on the market may be used. Specific examples include, but are not limited to, SURFLON S-111, SURFLON 5-112, SURFLON S-121, SURFLON S-131, SURFLON S-132, SURFLON S-141, and SURFLON S-145 (all manufactured by ASAHI GLASS CO., LTD.); FLUORAD FC93, FC-95, FC-98, FC-129, FC-135, FC-170C, FC-430, and FC-431 (all manufactured by SUMITOMO 3M); MEGAFACE F-470, F-1405, and F-474 (all manufactured by DIC CORPORATION); ZONYL TBS, FSP, FSA, FSN-100, FSN, FSO-100, FSO, FS300, UR, and Capstone™, FS-30, FS-31, FS-3100, FS-34, and FS-35 (all manufactured by The Chemours Company); FT-110, FT-250, FT-251, FT-4005, FT-150, and FT400SW (all manufactured by NEOS COMPANY LIMITED); POLYFOX PF-136A, PF-156A, PF-151N, PF-154, and PF-159 (manufactured by OMNOVA SOLUTIONS INC.); and UNIDYNE™, DSN-403N (manufactured by DAIKIN INDUSTRIES, Ltd.). Of these, in terms of improvement on print quality, in particular coloring property and permeability, wettability, and uniform dying property on paper, FS-3100, FS-34, and FS-300 of The Chemours Company, FT-110, FT-250, FT-251, FT-4005, FT-150, and FT-400SW of NEOS COMPANY LIMITED, POLYFOX PF-151N of OMNOVA SOLUTIONS INC., and UNIDYNE™, DSN-403N (manufactured by DAIKIN INDUSTRIES, Ltd.) are particularly preferable.

The proportion of the surfactant in the ink is not particularly limited and can be suitably selected to suit to a particular application. For example, it is preferably from 0.001 to 5 percent by mass and more preferably from 0.05 to 5 percent by mass in terms of excellent wettability and discharging stability and improvement on image quality.

Defoaming Agent

The defoaming agent has no particular limit. For example, silicon-based defoaming agents, polyether-based defoaming agents, and aliphatic acid ester-based defoaming agents are suitable. These can be used alone or in combination. Of these, silicone-based defoaming agents are preferable in terms of the effect of foam breaking.

Preservatives and Fungicides

The preservatives and fungicides are not particularly limited. A specific example is 1,2-benzisothiazoline-3-one.

Corrosion Inhibitor

The corrosion inhibitor has no particular limitation. Specific examples include, but are not limited to, acid sulfites and sodium thiosulfates.

pH Regulator

The pH regulator has no particular limit as long as it can control pH to not lower than 7. Specific examples include, but are not limited to, amines such as diethanol amine and triethanol amine.

Step of Applying Resin-Containing Liquid to Base Sheet

The method of manufacturing the laminate of the present disclosure may include applying a resin-containing liquid containing a resin to a base sheet (decorative base sheet) after the printing described above. Examples of a method of applying the resin-containing liquid include a method of immersing the decorative base sheet in the resin-containing liquid and a method of spray-coating the resin-containing liquid onto the decorative base sheet. The former is preferable.

It is because, due to this immersion of the decorative base sheet in the resin-containing liquid, the resin-containing liquid is uniformly applied, which has a good impact on mutual interaction between the components in the resin-containing liquid described later and the component in the ink. In addition, due to this immersion, the resin-containing liquid sufficiently permeates the inside of decorative base sheet, thereby obtaining a decorative base sheet having a strength suitable for a decorative board.

Resin-Containing Liquid

The resin-containing liquid contains a resin or a resin precursor and optionally contains other components. In the present application, the resin-containing liquid includes both of a case of containing a resin and a case of containing no resin but a resin precursor. Also, in the present disclosure, the resin precursor is a component producing a resin via a polymerization reaction and includes a monomer, an oligomer (dimer, trigomer, etc.), and a prepolymer. For example, the precursor of a melamine resin includes a composition containing a melamine compound such as the component represented by the following Chemical formula 1 and an aldehyde compound having an aldehyde group (—CHO) in a molecule such as formaldehyde.

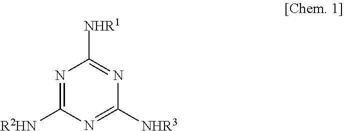

In Chemical formula 1, R¹, R², and R³ each, independently represent hydrogen atoms or hydrocarbon groups having 1 to 4 carbon atoms which may have substituents. It is preferable that both R¹, R², and R³ be hydrogen atoms at the same time.

The resin and the resin precursor are preferably an aqueous resin or an aqueous resin precursor. Aqueous means a state in which a resin is dissolved in water, a state in which a resin is dispersed or suspended in water, or a state in which a resin precursor is dispersed or a suspended in water.

Specific examples of the resins include, but are not limited to, thermocurable resins such as amino resins, unsaturated polyester resins, diallyl phthalate resins, phenolic resins, urea resins, and epoxy resins, and water-soluble resins such as polyvinyl alcohols, cellulose derivatives, and polyvinyl pyrrolidones.

Specific examples of the resin precursors include, but are not limited to, those of thermocurable resins such as amino resins, unsaturated polyester resins, diallyl phthalate resins, phenolic resins, urea resins, and epoxy resins, and water-soluble resins such as polyvinyl alcohols, cellulose derivatives, and polyvinyl pyrrolidones. These resins and resin precursors may be used alone or in combination.

Further, it is preferable that the resin and the resin precursor cause the decorative base sheet and other members, for example, a substrate and an overcoat, which are described later, to adhere to each other in the step of applying heat and pressure to form a laminate, which is described later. Therefore, cross-linkable resins and cross-linkable resin precursors are preferable, amino resin precursors are more preferable, and melamine resin precursors are furthermore preferable. In the present disclosure, cross-linkable means that a resin or a resin precursor cross-links with or without a cross-linking agent. Cross-linking without a cross-linking agent is preferable.

The resin-containing liquid may contain a solvent or a dispersion medium. The solvent is a liquid dissolving at least one of the resin and the resin precursor contained in a resin-containing liquid. In addition, the dispersion medium is a liquid dispersing at least one of the resin and the resin precursor contained in a resin-containing liquid.

Specific examples of the solvent and the dispersion medium include, but are not limited to, organic solvents such as alcohols and ketones and water, which is preferable.

The proportion of the resin and the resin precursor in the resin-containing liquid is not particularly limited, can be suitably selected to suit to a particular application. Preferably, it is from 5.0 to 6.0 percent by mass. The proportion of the solvent or the dispersion medium in the resin-containing liquid is not particularly limited and can be suitably selected to suit to a particular application. Preferably it is from 30.0 to 98.0 percent by mass.

In addition, the resin-containing liquid may contain the specified-above additives of an ink as the other optional components.

Step of Forming Laminate

The method of manufacturing a laminate of the present disclosure may include a step of applying a resin-containing liquid containing a resin to a decorative base sheet after printing.

Specifically, at least one of the resin and the resin precursor applied to the decorative base sheet reacts with alcohol having a boiling point of 180 degrees C. or higher as a component of the ink to form a covalent bond for cross-linking (solidification) to obtain a laminate.

As the method of removing (drying) the liquid contained in the decorative base sheet, for example, preferred are a method of heating the decorative base sheet by a heating device, a method of irradiating the decorative base sheet with ultraviolet rays by an ultraviolet ray irradiation device, a method of irradiating the decorative base sheet with electron beams by an electron beam irradiation device. Of these, the method of heating is preferable. This is because the method of heating does not impair productivity since it does not require any new additional step to a typically general manufacturing process. In addition, due to the method of heating by a heating device, it is possible to vaporize and remove the liquid, i.e., solvent and water, contained in the decorative base sheet, thereby enhancing adhesiveness of the laminate. The heating device is not particularly limited as long as it is a known device. For example, a heated air blowing device using hot air, an infrared drying device using an infrared lamp, a heating roller on which a decorative base sheet is caused to pass, and a dielectric heating device utilizing dielectric heating can be used.

Due to the removal of the liquid contained in the decorative base sheet as described above, the amount of the liquid present at the interface of the laminate is decreased when the decorative base sheet is laminated with a member such as the substrate and the overlay layer, thereby reducing degradation of adhesiveness in the laminate (decorative board). In addition, in the step of solidifying by “cross-linking”, the coloring material contained in ink applied to the decorative base sheet is simultaneously taken in. Due to this, the position of the coloring material is fixed in the decorative base sheet, so that a laminate (decorative printing sheet, a decorative board) having a print layer with a high image density can be obtained. Moreover, since the laminate has a cross-linked structure, alcohol having a boiling point of 180 degrees C. or higher forms a covalent bond and cross-links (solidifies) with at least one of the resin and the resin precursor applied to the decorative base sheet. Production of bubbles ascribable to vaporization can be diminished in the step of preparing a laminate by heating and pressurizing, which is described later. This makes it possible to reduce degradation of adhesiveness in the laminate.

Device for Manufacturing Laminate

The device for manufacturing a laminate relating to the present disclosure may include a device for printing onto a medium such as a decorative base sheet and a device for applying a resin-containing liquid containing a resin to a medium such as a decorative base sheet. Also, in such a case, it can furthermore optionally include a drying device such as a heater. The device for manufacturing a laminate is described below.

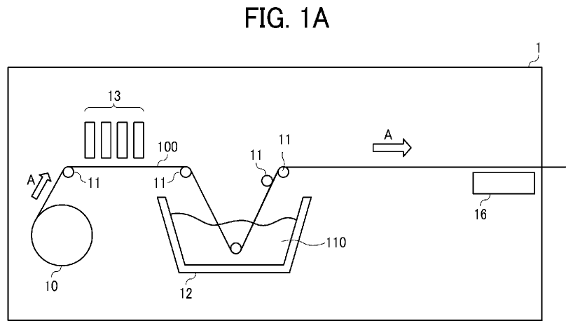

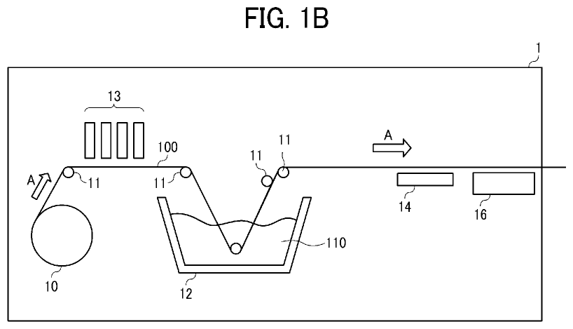

FIG. 1A is a schematic diagram illustrating the device for manufacturing a laminate according to an embodiment of the present disclosure. A manufacturing device 1 for manufacturing a laminate illustrated in FIG. 1A includes a decorative base sheet supplying device 10, a conveyor roller (conveying device) 11, a resin containing liquid immersion tank 12, a liquid discharging head 13, and a laminating device 16.

The decorative base sheet supplying device 10 rotates to supply a decorative base sheet along the conveyance direction indicated by the arrow A. The decorative base sheet supplying device 10 does not necessarily rotate on its own but can be rotationally driven by another drive member to convey the decorative sheet.

The conveyor roller 11 rotates to convey the decorative base sheet supplied to the manufacturing device 1 for manufacturing a laminate along a conveyance path 100 in the manufacturing device 1. The conveyor roller 11 does not necessarily rotate on its own but can be rotationally driven by another drive member to convey the decorative sheet.

The resin containing liquid immersion tank 12 carries a resin-containing liquid 110 inside and the decorative base sheet passes on the conveyance path 100 where the decorative base sheet is immersed in the resin-containing liquid 110. Due to this, the resin-containing liquid is applied to the decorative base sheet. This applies to the case in which the resin-containing liquid 110 containing a resin is applied to a medium such as a decorative base sheet. However, the resin-containing liquid 110 is not necessarily used when the resin-containing liquid 110 is not applied to a medium such as a decorative base sheet. In such a case, it is possible to dispose a device for laminating an overlay layer containing a resin on the surface of a print layer and a device for laminating the decorative base sheet on which the overlay layer is laminated on a substrate upstream of the device for heating and pressurizing a laminar object to obtain a laminate.

The liquid discharging head 13 includes multiple nozzle lines each of which has multiple nozzles. The liquid discharging direction from the nozzles is oriented to the conveyance path 100 of the decorative base sheet.

Each liquid discharging head sequentially discharges liquid of ink of magenta (M), cyan (C), black (K), and yellow (Y) in this order onto the decorative base sheet to form a print layer.

The liquid discharging head 13 may discharge the liquid by a pressure generated by a pressure generating device. As the device for discharging the liquid from the liquid discharging head 13, it is possible to use, for example, a piezoelectric actuator (which may include a laminated piezoelectric element), a thermal actuator using an electrothermal transducer such as a heat element, and an electrostatic actuator including a plate and a counter electrode.

FIG. 1B is a diagram illustrating an embodiment in which the heating device 14 is disposed upstream of the laminating device 16 to apply a substrate for the device illustrated in FIG. 1A.

The heating device 14 heats the decorative base sheet on which the print layer is formed. As a result, the liquid contained in the decorative base sheet is evaporated.

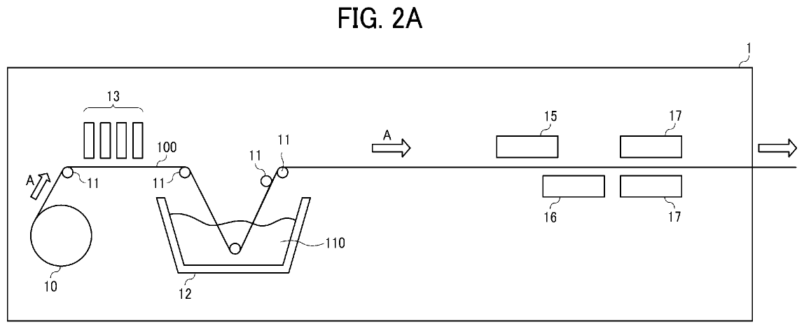

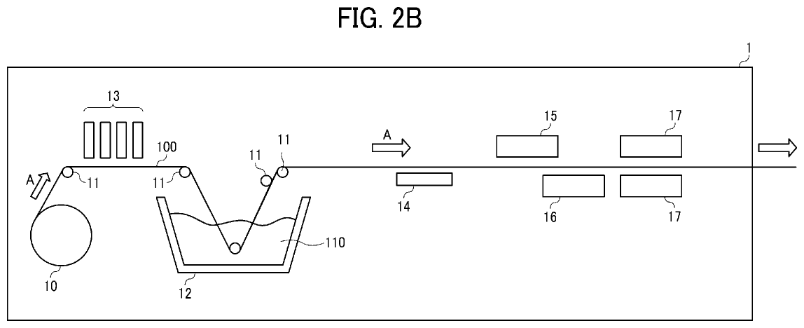

The manufacturing device 1 for manufacturing a laminate illustrated in FIG. 2A further includes a laminating device 15 for laminating the overlay layer and a heating and pressurizing device 17 to laminate the base sheet, the substrate, the overlay layer, etc., and heat them under a pressure against the device illustrated in FIG. 1A.

FIG. 2B is a diagram illustrating an embodiment in which the heating device 14 is added to the device illustrated in FIG. 2A.

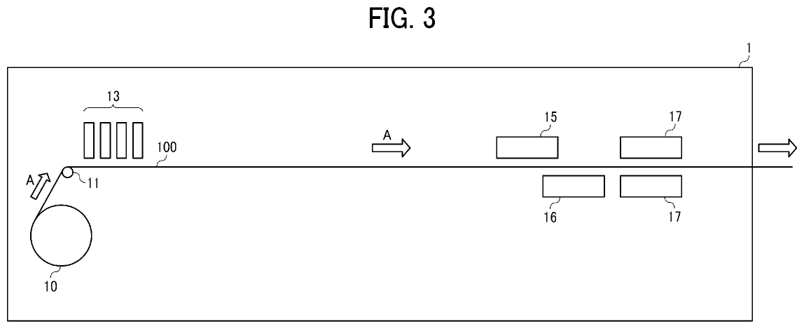

FIG. 3 is a diagram illustrating an embodiment excluding the resin-containing liquid immersion tank 12 from the configuration illustrated in FIG. 2A. To laminate the overlay layer containing the resin, it is possible to use the device illustrated in FIG. 3. Having generally described preferred embodiments of this disclosure, further understanding can be obtained by reference to certain specific examples which are provided herein for the purpose of illustration only and are not intended to be limiting. In the descriptions in the following examples, the numbers represent weight ratios in parts, unless otherwise specified.

### EXAMPLES

Next, the present disclosure is described in detail with reference to Examples but is not limited thereto.

In the following description, “percent” means “percent by mass” unless otherwise specified.

Manufacturing Example of Ink

Manufacturing Examples of ink are described below.

In addition, the product name and the manufacturer name of the ink component used for preparing the ink are shown in Table 1 below.

TABLE 1

| Ink | Product name and |
|---|---|
| component | manufacturer name |
| Pigment | Regal 400R (carbon black pigment, |
| | manufactured by Cabot Corporation) |
| Pigment | Solsperse 39000 (manufactured by |
| dispersant | Lubrizol Corporation) |
| Alcohol | Polyethylene glycol monomethyl ether |
| solvent | (boiling point of 290 to 310 |
| | degrees C., Himole PM, manufactured |
| | by Toho Chemical Industry Co., Ltd.) |
| | Diethylene glycol monobutyl ether |
| | (boiling point of 230 degrees C., |
| | manufactured by Tokyo Chemical |
| | Industry Co., Ltd.) |
| | 1,3-butane diol (boiling point of 207 |
| | degrees C., manufactured by Tokyo |
| | Chemical Industty Co. Ltd.) |
| | 2,3-butane diol (boiling point of 183 |
| | degrees C., manufactured by |
| | FUJIFILM Wako Pure Chemical |
| | Industries, Ltd.) |
| | Tetrahydrofurfuryl alcohol (boiling |
| | point of 178 degrees C., manufactured |
| | by Tokyo Chemical Industry Co., Ltd.) |
| Non-alcohol | Dipropylene glycol dimethyl ether (boiling |
| solvent | point of 175 degrees C., manufactured |
| | by Tokyo Chemical Industry Co., Ltd.) |
| Surfactant | Pionin A-51-B (anionic surfactant, manu- |
| | factured by Takemoto Oil & Fat Co., Ltd.) |
| | Zonyl FS-300 (nonionic surfactant, manu- |
| | factured by E. I. du Pont de Nemours and |
| | Company) |

Preparation of Ink 1

After preliminarily mixing the following formulation, the mixture was circulated and dispersed for seven hours in a disk-type bead mill (KDL type, media of zirconia ball having a diameter of 0.3 mm, manufactured by SHINMARU ENTERPRISES CORPORATION). Thereafter, the resultant was filtered through a 0.2 μm polypropylene filter to prepare Ink 1.
Carbon black pigment: 6.0 percent
Pigment Dispersant: 2.5 percent
Anionic surfactant: 0.5 percent
Nonionic surfactant: 1.0 percent
Alcohol (polyethylene glycol monomethyl ether): 90.0 percent
Deionized water: 0.0 percent

Preparation of Inks 2 to 7

Inks 2 to 7 were prepared in the same manner as in Preparation of Ink 1 except that the compositions and the proportions (percent by mass) were changed to those shown in the following Table 2.

TABLE 2

| Ink component | | Ink 1 | Ink 2 | Ink 3 | Ink 4 | Ink 5 | Ink 6 | Ink 7 |
|---|---|---|---|---|---|---|---|---|
| Pigment (carbon black) | | 6.0 | 6.0 | 6.0 | 6.0 | 6.0 | 6.0 | 6.0 |
| Pigment | Solsperse 39000 | 2.5 | 2.5 | 2.5 | 2.5 | 2.5 | 2.5 | 2.5 |
| dispersant | | | | | | | | |
| Alcohol | Polyethylene glycol | 90.0 | | | 40.0 | 30.0 | | |
| solvent | monomethyl ether | | | | | | | |
| | (boiling point of | | | | | | | |
| | 290 to 310 | | | | | | | |
| | degrees C.) | | | | | | | |
| | Diethylene glycol | | 80.0 | | | 30.0 | | |
| | monobutyl other | | | | | | | |
| | (boiling point of | | | | | | | |
| | 230 degrees C.) | | | | | | | |
| | 1,3-butanediol | | | 70.0 | | 20.0 | | |
| | (boiling point of | | | | | | | |
| | 207 degrees C.) | | | | | | | |
| | 2,3-butanedol | | | | 40.0 | | | |
| | (boiling point of | | | | | | | |
| | 183 degrees C.) | | | | | | | |
| | Tetrahydrofurfuryl | | | | | | 80.0 | |
| | alcohol (boiling | | | | | | | |
| | point of 178 | | | | | | | |
| | degrees C.) | | | | | | | |
| Non-alcohol | Dipropylene | | | | | | | 80.0 |
| solvent | glycol dimethyl | | | | | | | |
| | ether (boiling point | | | | | | | |
| | of 175 degrees C) | | | | | | | |
| Surfactant | Pionin A-51-B | 0.5 | 0.5 | 0.5 | 0.5 | 0.5 | 0.5 | 0.5 |
| | Zonyl ™ FS-300 | 1.0 | 1.0 | 1.0 | 1.0 | 1.0 | 1.0 | 1.0 |

| | | | | | | | |
|---|---|---|---|---|---|---|---|
| Deionized water | 0.0 | 10.0 | 20.0 | 10.0 | 10.0 | 10.0 | 10.0 |
| Total of each component | 100.0 | 100.0 | 100.0 | 100.0 | 100.0 | 100.0 | 100.0 |

Decorative Base Sheet

KSH-801P (basis weight of 80 g/m², ash proportion of 32 percent, manufactured by KJ Specialty Paper Co., Ltd.) was used as the decorative base sheet.

Manufacturing Example of Resin-containing Liquid

Preparation of Resin-Containing Liquid 1

Polyvinyl alcohol resin (POVAL JP-03, manufactured by JAPAN VAM & POVAL CO., LTD.) was mixed with water in such a manner that the solid content concentration was 15 percent by mass to prepare Resin-containing Liquid 1.

Preparation of Resin-Containing Liquid 2

Water-soluble melamine (Nika-resin S-176, methylolmelamine, manufactured by NIPPON CARBIDE INDUSTRIES CO., INC.) as a melamine resin precursor was mixed with water in such a manner that the solid content concentration was 20 percent by mass to prepare Resin-containing Liquid 2.

Preparation of Resin-Containing Liquid 3

Water soluble resole phenolic resin (IG-1002, manufactured by DIC Corporation) and water-soluble melamine (Nika-resin S-176, methylol melamine, manufactured by NIPPON CARBIDE INDUSTRIES CO., INC.) as a melamine resin precursor were mixed with water in such a manner that the solid content concentration was 25 percent by mass and the molar ratio of the water-soluble resole phenolic resin to water-soluble melamine was 5 to 4 to prepare Resin-containing Liquid 3.

Manufacturing Example of Decorative Board

### Example 1

A solid image was printed on the decorative base sheet using OnePassJET (manufactured by TRITEK CO., LTD.) equipped with an inkjet head (MH 5420, manufactured by Ricoh Company Ltd.) at 1,200 dpi at a printing speed of 30 m/min. Also, at the time of printing, the temperatures of the inside of the head and the ink supply unit were kept in such a manner that viscosity of the ink was in the range of from 10 to 12 mPa-s, and the drive voltage waveform was adjusted in such a manner that the dot diameter on the decorative base sheet was 90 to 95 μm.

Thereafter, subsequent to hot-air drying (110 degrees C., two minutes), the decorative base sheet was immersed in the resin-containing liquid, and it was visually confirmed that the resin-containing liquid sufficiently permeated the decorative base sheet. Thereafter, the decorative base sheet was hot-air dried again (110 degrees C., two minutes) to obtain a decorative base sheet containing a resin.

Next, an MDF laminated material having a thickness of 15 mm, the thus-obtained decorative base sheet containing a resin, and an overlay base paper (OL-25 containing a melamine resin, manufactured by Ota Industry Co., Ltd.) were laminated in this order and inserted into a hot press and heated at 190 degrees C. at a pressure of 40 kg/cm² for a pressing time of 30 seconds to obtain Decorative board 1.

### Examples 2 to 9 and Comparative Examples 1 to 4

Decorative boards of Examples 2 to 9 and Comparative Examples 1 to 4 were manufactured in the same manner as in Example 1 except that the inks, whether the resin-containing liquid was used, and whether the overlay layer was provided were changed as shown in Table 3. The decorative boards of Examples 1 to 9 and Comparative Examples 1 to 4 were evaluated for adhesiveness and inkjet discharging stability according to the following methods and evaluation criteria.

Evaluation of Adhesiveness

The obtained decorative boards were evaluated for adhesiveness according to the cross-cut test (old standard) of JIS K 5400 format. In the following evaluation, an adhesiveness value of 100 means a state in which there is no peeling-off even at a single position of the cross-cut portions cut to 100 pieces. An adhesiveness value of 70 means a state in which the area of the non-peeled-off portion is 70 percent. Rated A or B means evaluated as practical. The results are shown in Table 3.

Evaluation Criteria

A: Adhesiveness from 80 to 100

B: Adhesiveness from 70 to less than 80

C: Adhesiveness less than 70

Evaluation of Ink Jet Discharging Stability

OnePassJET (manufactured by TRITEK CO., LTD.) equipped with an inkjet head (MH 5420, manufactured by Ricoh Company Ltd.) was filled with ink and continuously discharged the ink at 20 kHz for 30 minutes. Thereafter, the nozzle surface of the inkjet head was not capped and left still in the room temperature environment (temperature of 23 degrees C., relative humidity of 55 percent) for 30 minutes to visually confirm the state of discharging. Rated C or above are evaluated as practical. The results are shown in Table 3.

Evaluation Criteria

A: No abnormal discharge (nozzle clogging, curving, speed abnormality) recognized

B: No nozzle clogging but slight curving and speed abnormality recognized

C: Slight nozzle clogging, and also curving and speed abnormality recognized

D: Massive nozzle clogging, curving and speed abnormality recognized

TABLE 3

| | | | Resin- | | | |
|---|---|---|---|---|---|---|
| | | | containing | Overlay | | Discharging |
| | | Ink | Liquid | layer | Adhesiveness | stability |
| Example | 1 | 1 | 1 | Yes | B | A |
| | 2 | 1 | 2 | Yes | A | A |
| | 3 | 1 | 3 | Yes | A | A |
| | 4 | 2 | 3 | Yes | A | B |
| | 5 | 3 | 3 | Yes | A | C |
| | 6 | 4 | 3 | Yes | A | B |
| | 7 | 5 | 3 | Yes | A | B |
| | 8 | 1 | 3 | None | B | A |
| | 9 | 1 | None | Yes | B | A |
| Comparative | 1 | 6 | 1 | Yes | B | D |
| Example | 2 | 6 | 2 | Yes | A | D |
| | 3 | 6 | 3 | Yes | A | D |
| | 4 | 7 | 3 | Yes | C | D |

It was confirmed that the decorative boards of Examples 1 to 9 had good adhesiveness. As to adhesiveness, it was confirmed that Examples 2 to 7 using a cross-linkable resin were good. Further, inclusion of an alcohol-based solvent having a boiling point of 200 degrees C. or higher contributed to enhancement of discharging stability. Examples 1, 2, 3, 8, and 9 using polyethylene glycol monomethyl ether, which was an alcohol-based solvent having a boiling point of 290 degrees C. or higher, were particularly excellent regarding discharging stability. In addition, good adhesiveness was also obtained in the decorative board (Example 9) in which the overlay layer was laminated without the treatment of a resin-containing liquid. For the decorative boards of Comparative Examples 1 to 3, practical applicability was expected for adhesiveness. However, massive nozzle clogging, curving, and speed abnormality were confirmed regarding discharging stability so that the decorative boards of Comparative Examples 1 to 3 were not suitable for practical use. In Comparative Example 4, since an alcohol solvent was not contained, reactivity with the resin-containing liquid was not secured so that sufficient adhesiveness was not obtained.

The reason why the evaluation results of Examples were excellent is that excellent adhesiveness was obtained because dot formation on a decorative base sheet and penetration of resin into a decorative base sheet were good. With respect to discharging stability, due to selection of an alcohol solvent having a boiling point of 200 degrees C. or higher as the solvent contained in ink, it is inferred that solvent volatilization in the vicinity of the air interface in the nozzle can be reduced, thereby preventing occurrence of problems such as nozzle clogging.

Confirmation of Print Layer Having Cross-Linked Structure

0.1 gram of the print layer of each of the decorative sheets of Examples 1 to 9 and Comparative Examples 1 to 4 were taken out and placed in a 10 ml glass sample bottle to which four gram of tetrahydrofuran was added. The bottle was allowed to stand for 24 hours in an environment at a temperature of 23 degrees C. and a humidity of 55 percent. Thereafter, since the residue as insoluble matter was confirmed, inclusion of cross-linked structure in the print layer was confirmed in each of Examples 1 to 9 and Comparative Examples 1 to 4.

As described above, the print layer is taken out and tetrahydrofuran is added thereto to detect an insoluble portion, which makes it possible to confirm the presence of the cross-linked resin.

Confirmation of Reactivity of Alcohol and Melamine (Amino Resin)

In connection with Example 2 using Resin-containing Liquid 2 containing a melamine resin precursor, reactivity between melamine and polyethylene glycol monomethyl ether used as an alcohol in Example 2 was tested to confirm the reactivity. 10 parts of water-soluble melamine (Nika-resin S-176, methylolmelamine, manufactured by NIPPON CARBIDE INDUSTRIES CO., INC.), 0.2 part of polyethylene glycol monomethyl ether (boiling point of from 290 to 310 degrees C., Himole PM, manufactured by Toho Chemical Industry Co., Ltd.), and 10 parts of water were thoroughly stirred and stored at 80 degrees C. for two weeks. 0.1 gram of the thus-obtained solid matter was taken out and placed in a 10 ml glass sample bottle to which four gram of tetrahydrofuran was added. The bottle was left still for 24 hours in an environment of a temperature of 23 degrees C. and a humidity of 55 percent and the presence of polyethylene glycol monomethyl ether was not confirmed by liquid chromatography. This confirmed reactivity of water-soluble melamine with polyethylene glycol monomethyl ether.

Confirmation of Print Layer Including Alcohol Having Boiling Point of 180 Degrees C. or Higher

0.1 gram of the print layer of each of the decorative sheets of Examples 1 to 9 and Comparative Examples 1 to 3 were taken out and placed in a 10 ml glass sample bottle to which four gram of tetrahydrofuran was added. After the bottle was allowed to stand for 24 hours in an environment of a temperature of 23 degrees C. and a humidity of 55 percent, the presence of alcohol was confirmed by liquid chromatography. The detected alcohol is shown in Table 4 below. In any of Examples 1 to 9, the presence of alcohol having a boiling point of 180 degrees C. or higher was confirmed.

For Comparative Examples 1 to 3, alcohol having a boiling point of 180 degrees C. or higher was not detected.

TABLE 4

| | Detected alcohol (boiling point) |
|---|---|
| Example 1 | Polyethylene glycol monomethyl ether (boiling point of |
| | 290 to 310 degrees C.) |
| Example 2 | Polyethylene glycol monomethyl ether (boiling point of |
| | 290 to 310 degrees C.) |
| Example 3 | Polyethylene glycol monomethyl ether (boiling point of |
| | 290 to 310 degrees C.) |
| Example 4 | Diethylene glycol monobutyl ether (boiling point of |
| | 230 degrees C.) |
| Example 5 | 1,3-Butane diol (boiling point of 207 degrees C.) |
| Example 6 | Polyethylene glycol monomethyl ether (boiling point of |
| | 290 to 310 degrees C.) |
| | 2,3-butanediol (boiling point of 183 degrees C.) |
| Example 7 | Polyethylene glycol monomethyl ether (boiling point of |
| | 290 to 310 degrees C.) |
| | Diethylene glycol monobutyl ether |
| | (boiling point of 230 degrees C.) |
| | 1,3-Butane diol (boiling point of 207 degrees C.) |
| Example 8 | Polyethylene glycol monomethyl ether (boiling point |
| | of 290 to 310 degrees C.) |
| Example 9 | Polyethylene glycol monomethyl ether (boiling point of |
| | 290 to 310 degrees C.) |

Having now fully described embodiments of the present invention, it will be apparent to one of ordinary skill in the art that many changes and modifications can be made thereto without departing from the spirit and scope of embodiments of the invention as set forth herein.

### REFERENCE SIGNS LIST

1 Device for manufacturing laminate
10 Decorative board raw paper supply device
11 Transfer roller
12 Resin-containing solution dipping tank
13 Discharging head
14 Development device
15 Laminating device for laminating overlay layer
16 Laminating device for laminating substrate
17 Heating and pressurizing device
100 Conveyance path
110 Resin-containing liquid

### CROSS-REFERENCE TO RELATED APPLICATIONS

This patent application is based on and claims priority pursuant to 35 U.S.C. § 119 to Japanese Patent Application Nos. 2017-219676, 2018-141823, and 2018-185369, filed on Nov. 15, 2017, Jul. 27, 2018, and Sep. 28, 2018, respectively, in the Japan Patent Office, the entire disclosures of which are hereby incorporated by reference herein.

1-12. (canceled)

13. A laminate, comprising:
a substrate;
a decorative base sheet;
a print layer comprising an alcohol having a boiling point of 180 degrees C. or higher; and
a cross-linked resin.

14. The laminate according to claim 13, wherein the alcohol is a cross-linking component of the cross-linked resin.

15. The laminate according to claim 13, wherein the decorative base sheet comprises a resin.

16. The laminate according to claim 13, further comprising an overlay layer comprising a resin.

17. The laminate according to claim 15, wherein the resin in the decorative base sheet comprises an amino resin.

18. The laminate according to claim 16, wherein the resin in the overlay layer comprises an amino resin.

19. The laminate according to claim 13, wherein the alcohol has a boiling point of 230 degrees C. or higher.

20. A method of manufacturing the laminate of claim 13, comprising:
jetting an ink comprising an alcohol having a boiling point of 180 degrees C. or higher as a solvent to a decorative base sheet to form a print layer;
applying a resin-containing liquid to the decorative base sheet;
laminating the decorative base sheet onto a substrate to obtain a laminar object; and
applying heat and pressure to the laminar object to form the laminate.

21. The method according to claim 20, further comprising laminating an overlay layer on a surface of the print layer.

22. A method of manufacturing a laminate, the method comprising:
jetting an ink comprising an alcohol having a boiling point of 180 degrees C. or higher as a solvent to a decorative base sheet to form a print layer;
laminating an overlay layer on a surface of the print layer;
laminating the decorative base sheet to a substrate to obtain a laminar object; and
applying heat and pressure to the laminar object to form the laminate, wherein a proportion of the alcohol in the ink is 60 percent by mass or more.

23. A device for manufacturing the laminate of claim 13, comprising:
a conveying device to convey a decorative base sheet along a conveyance path;
an inkjet discharging device to discharge ink to form a print layer on the decorative base sheet;
an application device to apply a resin-containing liquid to the decorative base sheet;
a laminating device to laminate the decorative base sheet to a substrate to obtain a laminar object; and
a heating and pressurizing device to apply heat and pressure to the laminar object to obtain the laminate,
wherein the inkjet device and the application device are continuously disposed along the conveyance path, and
wherein the ink comprises an alcohol and a proportion of the alcohol in the ink is 60 percent by mass or more.

24. A device for manufacturing a laminate, the device comprising:
a conveying device to convey a decorative base sheet along a conveyance path;
an inkjet discharging device to discharge ink to form a print layer on the decorative base sheet an overlay layer laminating device to laminate an overlay layer comprising a resin on a surface of the print layer;
a laminating device to laminate the decorative base sheet to a substrate to obtain a laminar object; and
a heating and pressurizing device to apply heat and pressure to the laminar object to obtain the laminate,
wherein the inkjet device and the overlay layer-laminating device are continuously disposed along the conveyance path,
wherein the ink comprises an alcohol and a proportion of the alcohol in the ink is 60 percent by mass or more.

25. The device according to claim 24, wherein the decorative base sheet comprises a resin.

26. The device according to claim 24, wherein the overlay layer comprises a resin.

27. The device according to claim 25, wherein the resin in the decorative base sheet comprises an amino resin.

28. The device according to claim 26, wherein the resin in the overlay layer comprises an amino resin.

29. The device according to claim 24, wherein the alcohol having a having a boiling point of 230 degrees C. or higher.
